(19) United States
(12) Patent Application Publication
(10) Pub. No.: US 2016/0135444 A1
(43) Pub. Date: May 19, 2016

(54) QUICK SETTING TRAP WITH ENHANCED SAFETY FEATURES

(71) Applicant: Joseph Pomerantz, Moorpark, CA (US)

(72) Inventor: Joseph Pomerantz, Moorpark, CA (US)

(21) Appl. No.: 15/004,577

(22) Filed: Jan. 22, 2016

Related U.S. Application Data
(63) Continuation-in-part of application No. 14/247,624, filed on Apr. 8, 2014.
(60) Provisional application No. 61/810,153, filed on Apr. 9, 2013.
(60) Provisional application No. 62/106,596, filed on Jan. 22, 2015.

(51) Int. Cl. A01M 23/20

(52) U.S. Cl. CPC A01M 23/20

(57) ABSTRACT

Devices according to the present disclosure include humane animal traps that include convenient setting elements and/or safety features. These traps comprise a body, an entrance to the body, a door, a bias mechanism configured to bias the door toward a position, a setting mechanism to hold the door open against its bias and a trigger mechanism configured to release the setting mechanism. The setting elements can comprise features allowing for one-handed setting, such as a handle connected to the door and a setting-base portion connected to the bias mechanism. The safety features can include a connecting mechanism connected to the door, which can be configured to temporarily connect the open door to a portion of the trap body, such that the door cannot swing in accordance with its bias during baiting of the trap.

### CROSS REFERENCE TO RELATED APPLICATIONS

This application is a continuation in part of, and claims the benefit of, U.S. patent application Ser. No. 14/247,624 to Joseph Pomerantz, entitled ANIMAL TRAP, filed on Apr. 8, 2014, which claims priority from Provisional Application Ser. No. 61/810,153 to Joseph Pomerantz, also entitled ANIMAL TRAP, filed on Apr. 9, 2013. This application also claims the benefit of U.S. Provisional Patent Application Ser. No. 62/106,596 to Joseph Pomerantz, entitled QUICK SETTING TRAP WITH ENHANCED SAFETY FEATURES, filed on Jan. 22, 2015. All of these applications are hereby incorporated herein in their entirety by reference.

### BACKGROUND

1. Field of the Invention

The present invention relates generally to animal traps, for example, humane “no-kill” animal traps for trapping small animals such as rodents, raccoons and opossums, and specifically to animal traps comprising convenient setting features and/or safety features.

2. Description of the Related Art

Throughout history, various innovations concerning pest control, and specifically animal traps, have had a significant importance, impact and demand in human society. So much so that the phrase “building a better mousetrap” has become synonymous with innovation. Indeed, each year pests cause significant property damage, monetary loss and proliferation of disease. While some pests, for example, most mice and insects, are often seen as vermin and traps that injure or kill these pests are commonly utilized, an individual might want to simply capture and release other pests, for example, raccoons and rabbits or animals that are nuisance animals, but might be protected under conservation laws. As society has advanced the demand for humane “no-kill” animal traps, as well as traps comprising advances in easy-setting features and safety features has increased.

An example conventional humane animal trap, designed to catch and allow for the later release of a trapped animal is set forth in U.S. Pat. No. 8,782,946 to Bucher, entitled Cage Trap with Over-Center Set Mechanism. Traps such as these typically comprise a confined space with an entrance that can be opened and closed-off. The mechanism for opening and closing the entrance is typically a door that is biased toward the closed direction through use of a mechanism, such as a spring. Such conventional traps typically comprise a “set mechanism” utilized to place the trap into a “set” position, where the entrance is held open against the bias and an animal can enter the trap. These traps further comprise a “trip mechanism” that detects the animal's presence inside the trap and cause the trap to be sprung, thus closing off the entrance and trapping the animal.

While conventional traps, such as the one discussed above have some features allowing for convenient setting, these traps still suffer from deficiencies in convenience and safety. For example, the purported one-handed setting mechanism in the Bucher disclosure oftentimes requires two hands to even set the door in an open position without otherwise disturbing the trap: one to manually manipulate the over center setting mechanism and another to hold the body of the trap down so that it does not lift up during setting.

Furthermore, when one is baiting the conventional trap, one must place his or her hand into the enclosed space while the door is open and the trap is therefore in its “set” position. This can result in the user accidently setting off the trip mechanism and causing the door to shut on a portion of the user's hand or arm, resulting in injury. Even if a user had the foresight to utilize a tool such as a gripping rod to insert the bait into the set trap, this requires the user to carry such a tool around and furthermore this tool could be damaged by accidental triggering of the trap.

### SUMMARY

Described herein are animal traps, including humane animal traps, comprising convenient setting elements and safety features. In some embodiments, animal traps comprise a body defining a confined space in which to trap an animal with the body having at least one entrance into the confined space. One or more doors are configured with a bias mechanism to be biased in an open or closed position allowing or restricting access to the entrance respectively. A setting mechanism is configured to set the trap, such that the door is in a counter-biased position, for example, if the trap has a door biased to shut the entrance closed, the setting mechanism suspends the door in an open position against its bias such that the door will swing closed when the trap is tripped. The traps can further comprise a trigger mechanism that is configured to release the setting mechanism, such that the door swings to the position in accordance with its bias.

Convenient setting elements incorporating features of the present invention include setting elements that a user can utilize to manipulate the door and/or set the trap by only using a single hand. In some embodiments, the setting elements comprise a handle connected to the door and a setting-base portion connected to the bias mechanism. A user can position the door in the open position by pulling up on the handle and pushing in on the setting-base. In some embodiments, this by itself is sufficient to set the trap. In other embodiments, the user can lock the door in the open position with one hand using the setting elements, activate the trap's setting mechanism, and then unlock the door to set the trap. In still other embodiments, the user can operate the trap in a two handed fashion and hold the door open with the setting elements while further setting the trap.

Safety features incorporating features of the present invention include features that will prevent activation and springing of the trap by the trigger mechanism while the door is in the “open” position until such time another the user wants the trap to be actively set. In some embodiments, the safety features include a connecting mechanism connected to the door, which can be configured to temporarily connect the open door to a portion of the trap body such that the door cannot swing in accordance with its bias, for example, the door cannot close on a user's arm when the user is baiting the open trap near the trigger mechanism. In some embodiments, the connecting mechanism comprises a hook. In some embodiments, the connecting mechanism is attached to the handle of the setting elements, such that the trap can be conveniently set and/or locked in place simultaneously and/or with a single hand.

In one embodiment incorporating features of the present invention, an animal trap comprises a trap body defining an enclosed space and comprising an entrance to the enclosed space, a door configured with the entrance to allow or restrict access to the enclosed space, a bias mechanism biasing the door toward a closed position restricting access to the enclosed space, a setting mechanism configured to hold the door against its bias in an open position allowing access to the enclosed space when the animal trap is in a set position, a trigger mechanism configured to release the setting mechanism such that the door will move to a closed position according to its bias, and a safety feature configured to hold the door in said open position against its bias when the safety feature is in use.

In another embodiment incorporating features of the present invention, an animal trap comprises a trap body defining an enclosed space and comprising an entrance to the enclosed space, a door configured with the entrance to allow or restrict access to the enclosed space, a bias mechanism biasing the door toward a closed position restricting access to said enclosed space, the bias mechanism comprising an auxiliary base portion and a spring mechanism, a setting mechanism configured to hold the door against its bias in an open position allowing access to the enclosed space when the animal trap is in a set position, a trigger mechanism configured to release the setting mechanism such that the door will move to a closed position according to its bias, a safety feature connected to the auxiliary base portion, the safety feature comprising a connector and a handle, and a setting base connected to the auxiliary base portion, the setting base configured such that force applied to the setting base causes movement of the auxiliary base portion.

In yet another embodiment incorporating features of the present invention, a safety feature for use with an animal trap comprising a trap body and at least one door comprising at least one end moveably connected to the animal trap, one or more connectors opposite the at least one end moveably connected to the animal trap, and one or more handles.

These and other further features and advantages of the invention would be apparent to those skilled in the art from the following detailed description, taking together with the accompanying drawings, in which:

### BRIEF DESCRIPTION OF THE DRAWINGS

FIG. 1 is a side view of an animal trap incorporating features of the present invention;

FIG. 2 is an expanded front partial perspective view the animal trap of FIG. 1;

FIG. 3 is an expanded front partial perspective view the animal trap of FIG. 1;

FIG. 4 is an expanded front partial perspective view the animal trap of FIG. 1;

FIG. 5 is an expanded front partial perspective view the animal trap of FIG. 1; and

FIG. 6 is an expanded front partial perspective view the animal trap of FIG. 1.

### DETAILED DESCRIPTION

Embodiments according to the present disclosure include traps that comprise various convenient setting elements and/or safety features. As mentioned above, these traps can include humane animal traps that allow a user to catch and later release a live animal without harming or killing it. While the convenient setting elements and safety features disclosed herein can be utilized with any compatible trap that is known in the art, they are particularly useful when utilized in operation with traps in which the trap comprises a body defining a confined space having at least one entrance and a door configured to allow or restrict access to the at least one entrance.

Animal traps in which the convenient setting elements and/or safety features of the present disclosure can be incorporated include animal traps wherein the door is biased toward an “open” or “closed” position by a bias mechanism, for example, a spring-like mechanism, although it is understood that any mechanism capable of providing a bias can be utilized, including any bias mechanism known in the art. Typically, such traps have the door biased toward the closed position, such that the door will swing closed from an open position, however, it is conceivable that a trap can be designed that is biased toward an open position.

A setting mechanism and a tripping mechanism are utilized to set and activate the trap respectively. The setting mechanism is configured to hold the door in a counter-biased position, for example, if the trap has a door biased to shut the entrance closed, the setting mechanism suspends the door in an open position against its bias such that the door will swing closed when the trap is tripped by the tripping mechanism. The tripping mechanism typically functions by releasing the setting mechanism. Various setting and tripping mechanisms are described herein.

Convenient setting elements according to the present disclosure include elements configured to increase the efficiency by which one sets the trap, for example, making it easier to manipulate the door, bias mechanism and/or setting mechanism to more efficiently place the trap in a “set” configuration. In some embodiments, the setting elements allow for simultaneous manipulation of one or more of the bias mechanism and setting mechanisms. In some embodiments, the setting elements enable one-handed trap setting. In some embodiments, the setting elements comprise a handle connected to the door and a setting-base portion connected to the bias mechanism. A user can position the door in the open position by pulling up on the handle and pushing in on the setting-base.

Improved safety features according to the present disclosure include features that allow for the door to be held in a position against its biased (in most cases an open position), such that the trap can be baited by the user inserting his or her hand into the trap without the danger of the trap accidently activating and harming the user, for example, if the user were to accidently activate the trigger mechanism. In humane embodiments, these safety features can also be configured to hold the door open when the animal is being released. This allows for a user to have the door held in an open position against its bias without manually holding open the door or resorting to utilizing an additional object to prop the door open. This allows the door to be held open for animal release without the user being near the trap, which can scare the animal due to the user's proximity and potentially lead to injury of the user and/or the animal.

In some embodiments, the safety features include a connecting mechanism connected to the door, which can be configured to temporarily connect the open door to a portion of the trap body, such that the door cannot swing in accordance with its bias. In some embodiments, the connecting mechanism comprises a hook. In some embodiments, the connecting mechanism is attached to the handle of the setting elements, such that the trap can be conveniently set and/or locked in place simultaneously and/or with a single hand.

Throughout this description, the preferred embodiment and examples illustrated should be considered as exemplars, rather than as limitations on the present invention. As used herein, the term “invention,” “device,” “method,” “present invention,” “present device” or “present method” refers to any one of the embodiments of the invention described herein, and any equivalents. Furthermore, reference to various feature(s) of the “invention,” “device,” “method,” “present invention,” “present device” or “present method” throughout this document does not mean that all claimed embodiments or methods must include the referenced feature(s).

It is also understood that when an element or feature is referred to as being “on” or “adjacent” to another element or feature, it can be directly on or adjacent to the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present. For example, if a bias mechanism is connected to the door, and a safety feature is directly connected to the bias mechanism, the safety feature is also connected to the door. In further example, if the bias mechanism comprises an auxiliary base portion and a safety feature is directly connected to the auxiliary base portion, the safety feature is connected to the bias mechanism.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

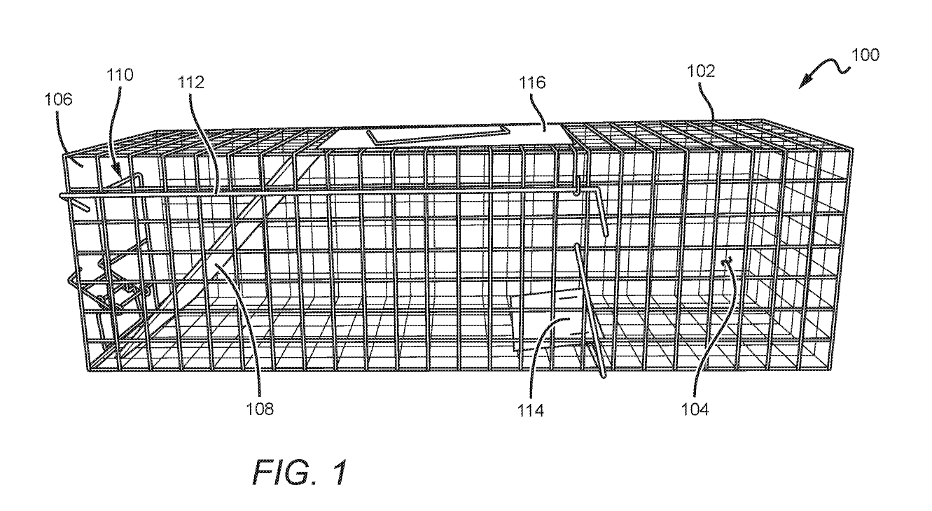

An overview of an animal trap 100 incorporating features of the present invention is shown in FIG. 1. The animal trap 100 comprises a body 102, which defines an enclosed space 104. The animal trap 100, further comprises an entrance 106 to the enclosed space 104, which is configured with a door 108, such that the door is configured to allow or restrict access to the enclosed space 104 from the entrance 106. The animal trap 100 further comprises a bias mechanism 110 configured with the door 108, such that the door is biased toward an open or closed position. In the embodiment shown, the door 108 is biased toward a closed position by the bias mechanism 110, such that the door will remain closed in absence of other force or structure opening the door 108 or holding the door 108 open against its bias.

The animal trap 100 further comprises a setting mechanism 112 configured to hold the door against its bias when the animal trap 100 is in its “set” configuration. In the embodiment shown, wherein the door 108 of the animal trap 100 is biased toward the closed position, the setting mechanism 112 is configured to hold the door 108 in an “open” position, such that when an animal triggers the trap, the setting mechanism 112 is released and the door 108 swings closed in accordance with its bias, thus trapping the animal within the enclosed space 104.

Various setting mechanisms can be utilized with embodiments of the convenient setting elements and/or safety features according to the present disclosure. In the embodiment shown, a “transfer arm” setting mechanism 112 is utilized wherein a user opens the door 108 and the door is held open by a portion of the transfer arm in communication with the open door. Another portion of the setting mechanism 112 is in communication with a trigger mechanism 114, which is depicted as a trip pad in the embodiment shown, such that the setting mechanism 112 will release the door 108 when an animal triggers the trip pad 114.

Further description and examples of such transfer arm setting and triggering mechanisms are set forth in U.S. application Ser. No. 14/247,624 filed on Apr. 8, 2014, entitled Animal Trap, to inventor Joseph Pomerantz (who is also the inventor of the invention of the present application), which is published as 2014/0298710 A1; this application is hereby incorporated herein in its entirety by reference.

Other setting mechanisms and triggering mechanisms can also be utilized with embodiments of the convenient setting elements and/or safety features according to the present disclosure, including any setting and trigger mechanisms that are known in the art, for example, mechanisms incorporating various spring-based mechanisms, pulley mechanisms, trip-wire mechanisms, as well as weight, temperature, pressure and motion sensors. The setting mechanism 112 and the trigger mechanism 114 of the trap 100 may be entirely mechanical in nature, entirely electrical in nature, or comprising a combination of electrical and mechanical components.

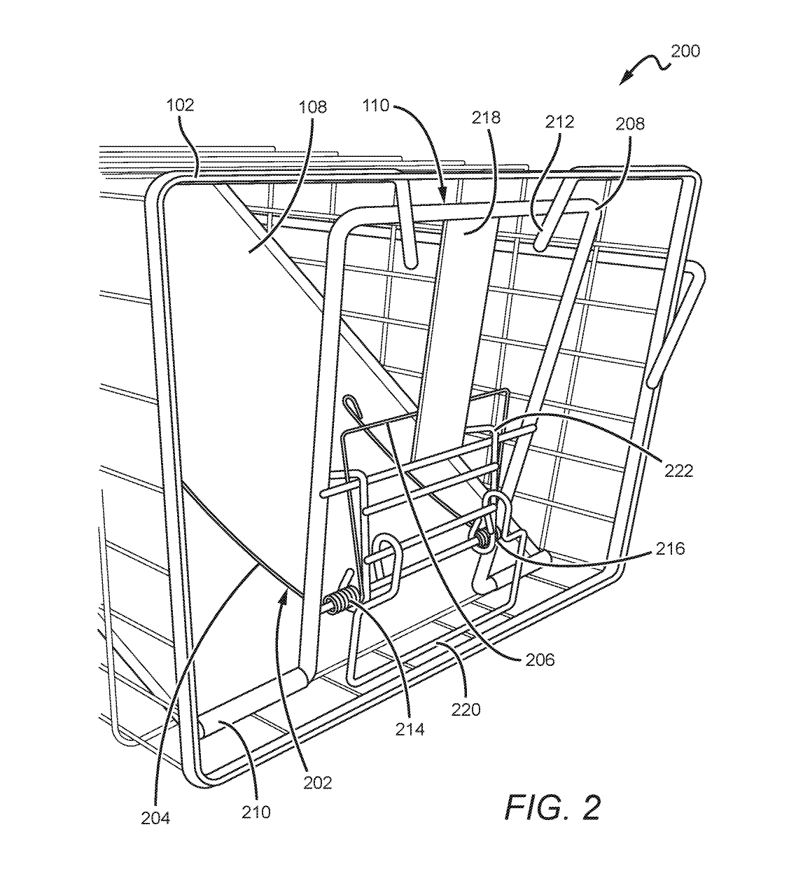

Various bias mechanisms can be used with the animal trap 100. FIG. 2 shows an expanded partial view 200 of the animal trap 100 of FIG. 1, wherein like reference numbers are utilized to denote like features. FIG. 2 shows the animal trap body 102, the door 108, and the bias mechanism 110. In the embodiment shown, the bias mechanism 110 comprises a spring mechanism 202, which comprises one or more spring leg portions 204 (two shown) and at least one spring base portion 206 (one shown). The bias mechanism 110 can further comprise one or more auxiliary base portions 208 (one shown) which can be used in addition to the spring mechanism 206.

In a structure similar to the spring mechanism 206, the auxiliary base portion 208 can comprise one or more auxiliary leg portions 210 (two shown). In the embodiment shown, the leg portions 210 are connected to the top surface of the door 108. The animal trap can further comprise stop structures 212 that are configured to provide a resting area for the auxiliary base portion 208. The stop structures 212 can be part of the trap body 102 or can be a different structure connected to the trap body 102.

The spring mechanism 202 is configured with the door 108 and/or the auxiliary base portion 208 (in embodiments comprising an auxiliary base portion 208) such that the door 108 is biased in an open or closed position. In the embodiment shown, the door 108 is biased toward a closed position. The spring mechanism 202 can be connected to the auxiliary base portion at spring connection points 214, 216, such that the spring leg portions 204 apply force against the top surface of the door 108 and the spring base portion 206 applies force in a direction toward the auxiliary base portion 208, thus biasing the door 108 toward a downward and closed position.

The spring base portion 206 can apply force toward the auxiliary base portion 208, which is connected to the door 108 by its auxiliary leg portions 210 at one end and is pushing against the stop structures 212 at its other end. This causes the spring leg portions 204 and the auxiliary leg portions 210 to constantly push against the top surface of the door 108, therefore providing a consistent bias that holds the door closed and resists being opened. This constant bias allows for the trap to function properly by the addition or release of a setting mechanism that holds the door open against the bias. This constant bias also will resist attempts to open the door 108 by a trapped animal.

While specific bias mechanisms have been described herein, it is understood that any spring-based mechanism or other bias mechanism that is configured to bias the door 108 toward an open or closed position can be utilized, as can any bias mechanism that is known in the art.

Now that some example trap configurations have been set forth, convenient setting elements and/or safety features according to the present disclosure can be discussed. Two such convenient setting elements include the setting-base 218 and the setting-handle 220, which allow for manipulation of the door 108, the spring mechanism 202 and the auxiliary base portion 208. The setting-base 218 is connected to the auxiliary base portion 208, such that a user can apply force to the setting-base 218 and push the setting-base 218 toward the top surface of the door 108.

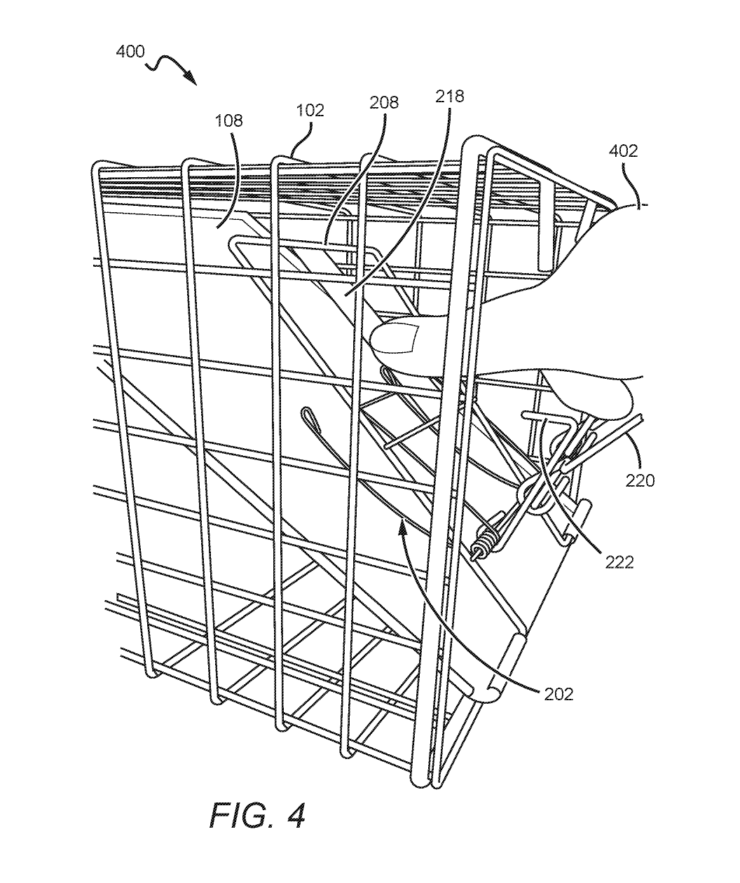

This compresses the spring mechanism 202, placing the top surface of the door 108, the spring leg portions 204 and the spring base portion 208 (and thus also the auxiliary base portion 208) close together and allowing for opening of the door 108. This operation is shown in more detail in FIGS. 4-6. At the same time the user applies force to the setting-base 218, the user can use the setting-handle 220 to lift the door 108 into an open position and set the trap. While the setting-handle 220 is shown and described as being a “handle,” it is understood that any gripping structure known can be utilized and configured to enable a user to provide a lifting motion sufficient to lift the door 108.

While the setting-base 218 shown comprises a base like object and acts against the spring mechanism 202, it is understood that in traps comprising other biasing mechanisms, setting-bases incorporating features of the present invention can be configured such that force applied to the setting-base applies counterforce to the biasing mechanism of the device allowing for easier movement of the door against its bias.

Also shown in FIG. 1 is an optional transportation mechanism 116, allowing for convenient transportation of the trap 100. In the embodiment shown, the transportation mechanism 116 comprises a handle connected to the trap body 102, which allows the user to grip the handle and lift the trap. It is understood that in lieu of or in addition to a handle, a variety of other transportation mechanisms 116 can be utilized, for example any mechanism connected to the trap body 102 allowing gripping and movement of the transportation mechanism 116 to translate to movement of the trap 100. In some embodiments, the transportation mechanism 116 is of sufficient dimensions such that a user can grip the transportation mechanism 116 and have his or her hand a sufficient distance from the trap 100, so that an animal inside the trap cannot reach the user.

Improved safety features are also shown in FIG. 2, for example, one or more safety connectors 222 (two shown) that can be configured to connect the door 108 to a portion of the trap body 102 when the trap is open to prevent the trap from activating when the safety features are engaged. While the safety connectors 222 are shown herein as hook-like structures that can hook onto portions of the animal trap body 102 to connect the door 108 to the body 102, it is understood that the safety connectors 222 can also comprise other connection structures including: suction cups, gripping mechanisms, hook and loop connections (such as Velcro®), male/female connections, adhesives, tapes and any connection configuration known in the art.

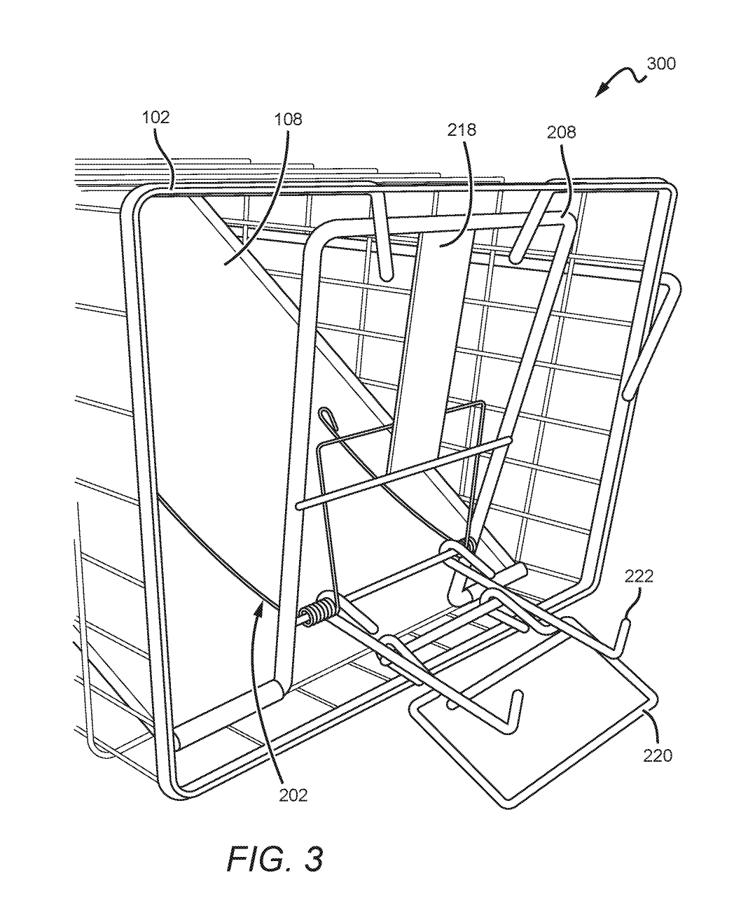

The safety connectors 222 can be configured such that they are part of the setting-handle 220 and can be configured with the setting-handle 220, such that the safety connectors 222 can be in a “closed” position when they are not in use (as shown in FIG. 2) or an “open” position when they are in use (as shown in FIG. 3). FIG. 2 shows that the safety connectors 222 can be configured with the setting-handle 220, such that the safety connectors 222 hold the handle tightly to the door 108 or auxiliary base portion 208 (as shown) when the safety connectors 222 are not in use. This allows for easy manipulation of the door 108, spring mechanism 202 and/or auxiliary base portion 208 through use of the setting-handle 220 when the safety connectors 222 are not needed. It is further understood that the safety connectors 222 can be permanently or temporarily moveably or non-moveably connected to the various parts of the trap, including, for example, the door 108, the bias mechanism 110, the auxiliary base portion 208, and/or the body 102 of the trap itself.

FIG. 3 shows an expanded partial view 300 of the animal trap 100 of FIG. 1, wherein like reference numbers are utilized to denote like features. FIG. 3 shows the trap body 102, the door 108, the spring mechanism 202, the auxiliary base portion 208, the setting-base 218, the setting-handle 220, and safety connectors 222. FIG. 3 illustrates safety connectors 222 in an “open” position where they are not connected to the door 108, the spring mechanism 202, and/or the auxiliary base portion 208, and are thus available for connecting the door 108 (to which the safety connectors are connected via the auxiliary base portion 208) to a portion of the trap body 102.

While the safety connectors 222 and setting-handle 220 are shown in FIG. 3 as being connected to the auxiliary base portion 208 at one end, thus allowing the other end comprising the safety connectors 222 to connect to the auxiliary base portion 208 when not in use as a safety feature (as shown in FIG. 2), and disconnect from the auxiliary base portion 208 when needed as a safety feature to connect to another structure, it is understood that different connection configurations can also be used. In some embodiments, a portion of the safety connectors 222 and setting-handle 220 are moveably connected to the auxiliary base portion 208, or another part of the bias mechanism of the device, or the door 108 itself, allowing for the safety connectors to move in relation to the auxiliary base portion 208 or the door 108 to allow the safety connectors 222 and setting-handle 220 to remain connected to the door while still adjusting its position between “open” and “closed” modes.

The safety connectors 222 and setting-handle 220 can be moveably connected to the door 108 and/or auxiliary bas portion 208 through any suitable moveable connection including, but not limited to, being positioned moveably around a portion of the door 108 or auxiliary base portion 208 (as shown), a standard hinge or living hinge connection, a ball and socket joint connection, a wheel connection, or any known moveable connection. Furthermore, in some configurations the safety connectors 222 and setting-handle 220 can be completely detachable and re-attachable to one or more portions of the trap.

Operation of the various convenient setting elements and/or safety features is shown in FIGS. 4-6. FIG. 4 shows an expanded partial view 400 of the animal trap 100 of FIG. 1, wherein like reference numbers are utilized to denote like features. FIG. 4 shows the trap body 102, the door 108, the spring mechanism 202, the auxiliary base portion 208, the setting-base 218, the setting-handle 220, and safety connectors 222.

Using a single hand, a user 402 can grip the setting-handle 220 in the palm of his or her hand while using his or her thumb to push the setting-base 218 toward the top surface of the door 108. This causes the spring mechanism 202 and auxiliary base portion 208 to press against the top portion of the door 108. The spring force is overcome by the application of manual force by the user's thumb. The change in position of the auxiliary base portion 208 allows the door 108 to open. The user 402 then can pull upward on the setting-handle 220, which is connected to the door 108 through the auxiliary base portion 208, thus lifting the door 108 to an open position, allowing access to the interior confined space of the trap body 102. While FIG. 4 shows the safety connectors 222 in an “open” position, that is, unconnected to the auxiliary base portion 208 and thus available for connection to a portion of the trap body 102, the trap can be operated with the safety connectors in the “closed” position as well.

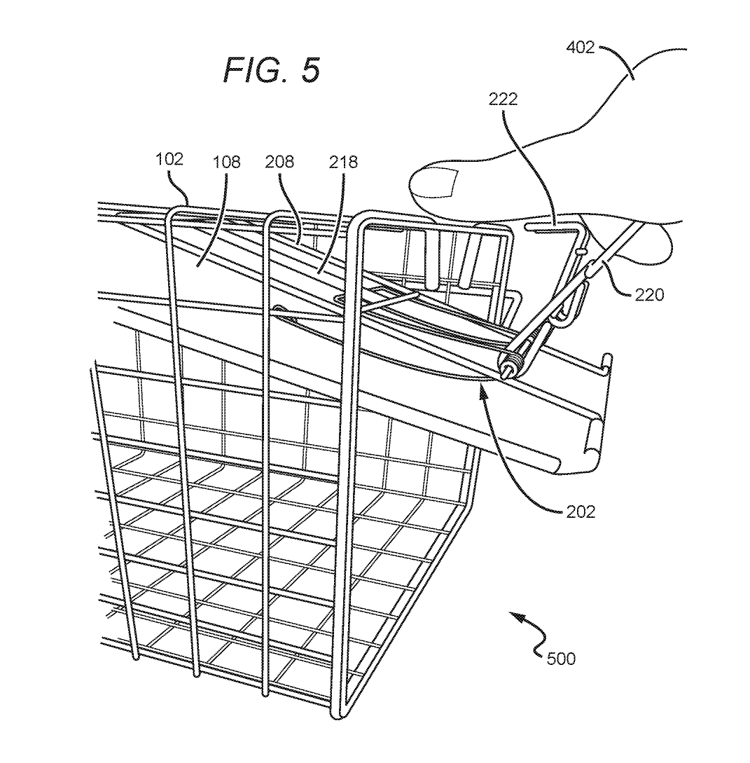

FIG. 5 shows continued operation of the various convenient setting elements and/or safety features. FIG. 5 shows an expanded partial view 500 of the animal trap 100 of FIG. 1, wherein like reference numbers are utilized to denote like features. FIG. 5 shows the trap body 102, the door 108, the spring mechanism 202, the auxiliary base portion 208, the setting-base 218, the setting-handle 220, and safety connectors 222.

After the spring mechanism 202 and the auxiliary base portion 208 have been pressed against the top portion of the door 108, such that the door can be pulled into an “open” position, it is no longer necessary for the user 402 to press against the setting-base 218; the user can change his or her grip to use his or her thumb to press against the top portion of the trap body 102 as he or she pull the door open by pulling up on the handle 220 as shown. This allows the user to open the door for trap setting utilizing only one hand without otherwise lifting the trap off the ground or otherwise disturbing the trap.

As shown in FIG. 5, the spring mechanism 202 and the auxiliary base portion 208 are pressed against the top portion of the door 108 and the top portion of the body 102, producing a tension force that urges the door 108 downward into a closed position, should the user remove his or her hand from the setting-handle 220. At this point the trap's setting mechanism can be engaged to set the trap and hold the door into the open position or to close in accordance with its downward bias in response to the setting mechanism being released.

In some embodiments, the setting mechanism can automatically activate once the door has been opened to a certain degree and the trap can be placed into a “set” configuration through the one handed operation. In other embodiments, the user can hold the door open while engaging the setting mechanism.

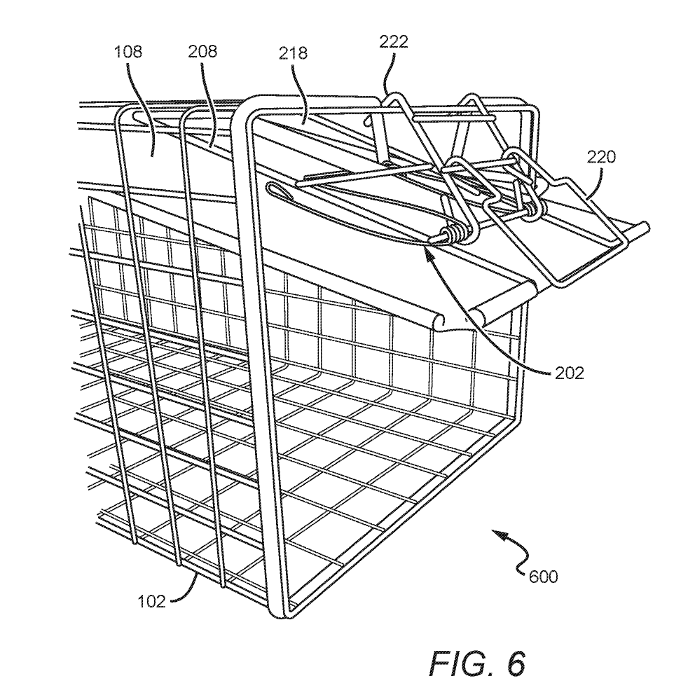

Operation of the safety connectors 222 is shown in FIG. 6, which shows an expanded partial view 600 of the animal trap 100 of FIG. 1, wherein like reference numbers are utilized to denote like features. FIG. 6 shows the trap body 102, the door 108, the spring mechanism 202, the auxiliary base portion 208, the setting-base 218, the setting-handle 220, and safety connectors 222. As shown in FIG. 6, the safety connectors 222 can connect the door 108 to a portion of the trap body 102, for example, a top portion of the trap body 102 as shown. By using the setting-handle 220 to lift the door 108 while the safety connectors 222 are in an open position as shown in FIGS. 4-5, a user can use the setting-handle 220 to connect the safety connectors 222 to the top of the trap body 102. In this position, if the trigger mechanism were tripped and the setting mechanism released, the door 108 would still not close as the bias of the door 108 toward the closed position is not sufficient to shut the door when the door is connected to a portion of the trap body 102.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention.

I claim:

1. An animal trap, comprising:
a trap body defining an enclosed space and comprising an entrance to said enclosed space;
a door configured with said entrance to allow or restrict access to said enclosed space;
a bias mechanism biasing said door toward a closed position restricting access to said enclosed space;
a setting mechanism configured to hold said door against its bias in an open position allowing access to the enclosed space when said animal trap is in a set position;
a trigger mechanism configured to release said setting mechanism such that said door will move to a closed position according to its bias; and
a safety feature, said safety feature configured to hold said door in said open position against its bias when said safety feature is in use.

2. The animal trap of claim 1, wherein said safety feature is connected to said door.

3. The animal trap of claim 2, wherein said safety feature is moveably connected to said door.

4. The animal trap of claim 1, wherein said safety feature is configured to connect said door to said trap body.

5. The animal trap of claim 1, wherein said safety feature comprises hook-like structures configured to connect.

6. The animal trap of claim 1, wherein said safety feature comprises a connector and a handle.

7. The animal trap of claim 6, wherein said safety feature is moveably connected to said door such that said connector can connect to said door or disconnect from said door.

8. The animal trap of claim 6, wherein movement of said handle causes movement of said door.

9. The animal trap of claim 1, wherein said safety feature is connected to said bias mechanism.

10. The animal trap of claim 9, wherein said safety feature is moveably connected to said bias mechanism.

11. The animal trap of claim 1, further comprising a setting base, said setting base configured such that force applied to the setting base applies counterforce to the biasing mechanism of the device allowing for easier movement of the door against its bias.

12. The animal trap of claim 11, further comprising a handle adjacent to said setting base.

13. An animal trap, comprising:
a trap body defining an enclosed space and comprising an entrance to said enclosed space;
a door configured with said entrance to allow or restrict access to said enclosed space;
a bias mechanism biasing said door toward a closed position restricting access to said enclosed space, said bias mechanism comprising an auxiliary base portion and a spring mechanism;
a setting mechanism configured to hold said door against its bias in an open position allowing access to the enclosed space when said animal trap is in a set position;
a trigger mechanism configured to release said setting mechanism such that said door will move to a closed position according to its bias;
a safety feature, said safety feature connected to said auxiliary base portion, said safety feature comprising a connector and a handle; and
a setting base connected to said auxiliary base portion, said setting base configured such that force applied to said setting base causes movement of said auxiliary base portion.

14. The animal trap of claim 13, wherein said handle of said safety feature is adjacent to said setting base.

15. The animal trap of claim 13, wherein said safety feature is moveably connected to said auxiliary base portion.

16. The animal trap of claim 13, wherein said safety feature is moveably connected to said auxiliary base such that said connector can connect to said auxiliary base or disconnect from said auxiliary base.

17. A safety feature for use with an animal trap comprising a trap body and at least one door, said safety feature comprising:
at least one end moveably connected to said animal trap;
one or more connectors opposite said at least one end moveably connected to said animal trap; and
one or more handles.

18. The safety feature of claim 17, wherein said at least one end is moveably connected to said door.

19. The safety feature of claim 18, wherein said one or more connectors are configured to connect to said door when said safety feature is not in use and to connect to one or more portions of said trap body when said safety feature is in use.

20. The safety feature of claim 18, wherein movement of said one or more handles causes movement of said door.
